(19) United States
(12) Patent Application Publication
(10) Pub. No.: US 2017/0188731 A1
(43) Pub. Date: Jul. 6, 2017

(54) DRINKING CONTAINER WITH SMART COMPONENTS FOR MEASURING VOLUMES OF LIQUIDS VIA CAVITY RESONANCE

(71) Applicant: IGNITE USA, LLC, Chicago, IL (US)

(72) Inventors: Tim Schuller, Cambridge (GB); Martyn Mitchell, Hertfordshire (GB); Thomas Barlow, Cambridge (GB)

(73) Assignee: IGNITE USA, LLC, Chicago, IL (US)

(21) Appl. No.: 15/391,217

(22) Filed: Dec. 27, 2016

Related U.S. Application Data
(60) Provisional application No. 62/275,678, filed on Jan. 6, 2016.

(51) Int. Cl. A47G 23/16; A47G 19/22; H04Q 9/00; B65D 47/06; B65D 51/24; A47G 21/18; B65D 43/02

(52) U.S. Cl. CPC A47G 23/16; A47G 21/18; A47G 19/2272; B65D 43/0225; B65D 47/06; B65D 51/245; H04Q 9/00; H04Q 2209/40

(57) ABSTRACT

A smart bottle comprising a lid and container body includes an actuator, a drinking interface, a sensor including a microphone, a processor including an antenna and a battery disposed in the smart bottle. The smart bottle utilizes the various components to perform acoustic measurements of a resonating cavity to measure liquid consumption of a user in one or more drink events.

### CROSS-REFERENCE TO RELATED APPLICATIONS

This claims the benefit of U.S. Provisional Application No. 62/275,678 (filed Jan. 6, 2016), the entirety of which is incorporated by reference herein.

### TECHNICAL FIELD

The present invention relates generally to drinking containers, and more particularly to a smart drinking container and a smart lid configured to measure the volume of liquid consumed by a user via cavity resonance techniques.

### BACKGROUND OF THE INVENTION

Drinking containers, including travel mugs, water bottles, and tumblers, are well known in the art. While such drinking containers according to the prior art provide a number of advantageous features, they do not reliably measure the amount of liquid consumed by a user. A full discussion of the features and advantages of the present invention is deferred to the following detailed description, which proceeds with reference to the accompanying drawings.

### BRIEF DESCRIPTION OF THE DRAWINGS

To understand the present invention, it will now be described by way of example, with reference to the accompanying drawings in which:

FIG. 1 is a front perspective view of one embodiment of a smart drinking container according to the present invention which is configured to measure the volume of liquid consumed by a user via cavity resonance;

FIG. 2 is a cross sectional view of one embodiment of a smart lid according to the present invention which is configured to measure the volume of liquid consumed by a user via cavity resonance;

FIG. 3 is a flow diagram illustrating one embodiment of a method for measuring the volume of a container body using a smart drinking container implementing an exemplary cavity resonance technique according to the present invention.

### DETAILED DESCRIPTION

While the invention described herein is susceptible of embodiments in many different forms, there is shown in the drawings and will herein be described in detail preferred embodiments of the invention with the understanding that the present disclosure is to be considered as an exemplification of the principles of the invention and is not intended to limit the broad aspects of the invention to the embodiments illustrated.

The present application provides a smart drinking container that can reliably measure the liquid consumption of a user. According to the present invention, a cavity resonance technique is used to measure the volume of liquid in the drinking container based on recorded frequencies of electromagnetic or mechanical waves propagated throughout the cavity. In this respect, an air cavity will exhibit a single resonant frequency that can be determined using the following equation (I):

F_{resonance}=(v/2π)×[√(A/VL)], where: (I)
v is the speed of sound (at the tested temperature);
A is the area of the cavity opening; and
L is the length of the opening port.
   Thus, the resonant frequency (F_{resonance}) is proportional to the square root of the volume of the cavity and decreases with increasing cavity volume. Because all of the other parameters relating to the resonant frequency are held substantially constant between measurements and the resonant frequency can be directly measured, the cavity volume (V) can be calculated using the following equation (II):

(II) F_{resonance}=C×[√L], where C is a constant corresponding to the parameters that remain substantially constant between measurements as described above.

The volume of the cavity corresponds to the “empty” volume in the drinking container. Of course, the volume of liquid in the drinking container can be easily calculated therefrom given that the volume of the empty drinking container is also known or can be determined by measuring the same using the above equations.

Generally, the smart drinking container according to the invention calculates the user's liquid consumption by measuring the volume of the container at a first time point and then again at one or more additional time points subsequent to the first time point using a resonant frequency technique, with the additional time point(s) being after a quantity of liquid has been consumed by the user. As used herein and consistent with the above description, the volume of fluid in the container is measured by determining the volume of the cavity in the container using a resonant frequency technique and then determining the amount of liquid in the container based upon the cavity volume and the known (or measured) volume of the drinking container as described above. For example, the smart drinking container can measure the liquid in the drinking container ab initio (prior to any fluid being consumed by the user) and then at various additional time points substantially immediately after a “drink event”, i.e., substantially immediately after a user has consumed, sipped, and/or drank liquid from the drinking container.

To perform the necessary measurements and calculations, the smart drinking container typically includes various components, which are communicatively coupled to one another and powered by a battery or other power source. For example, such components, generally referred to herein as “smart components,” include a processor, an actuator, a sensor such as, for example, a microphone, an amplifier and optionally an antenna.

In one embodiment, the volume of liquid in the drinking container may be measured substantially immediately after a drink event (e.g., after a user sips from a tumbler using a straw in fluid communication with the liquid contents of the tumbler, or after a user sips from a drinking aperture provided in a lid of a travel beverage container, or after a user sips from a spout of a water bottle), whereby the volume measurement is initiated through activation of an actuator substantially immediately after the drink event. In another embodiment, the volume measurement is conducted when it is determined, for example, by a tilt sensor, that the drinking container has been tilted and is positioned substantially vertically and/or at a state of rest.

In one refinement, the starting volume of liquid in the drinking container can be measured ab initio (prior to any fluid being consumed) by selective activation of the actuator (by the user), and subsequent drink events may then cause new volume measurements to be automatically retrieved. In an alternative refinement, the drinking container may be filled to a known starting volume by use of a graduated indicia on the interior or exterior of the container and subsequent drink events may then cause new volume measurements to be automatically retrieved. In yet another refinement, both the starting volume of liquid in the drinking container and the volume after one or more drink events can be measured by selective activation of the actuator (by the user), with or without automatic retrieval of new volume measurements subsequent to drink events. By comparing the current volume of liquid in the container to the initial volume of liquid in the container, the smart drinking container may determine a total volume of liquid displaced throughout the one or more drink events and thus the total volume of liquid consumed by the user. When refilling the drinking container with liquid, the user may choose to retain a prior measurement of total volume or liquid consumed such that the total volume is updated with additional quantities of liquid consumed after refilling the drinking container, or the user may instead choose to discard the prior measurement of total volume and start measuring the total volume consumed by the user anew from that point going forward.

The smart components of the drinking container according to the invention can be installed on or within a container body, on or within a lid for use in combination with a container body, and/or on or within any suitable combination of the container body and the lid. In an exemplary embodiment, each of the smart components may be installed within the lid. In such an embodiment, the lid, referred to herein as a “smart lid”, provides several advantages. For example, the smart lid according to the invention may be compatible with various container bodies (of different size and/or shape), thus allowing a user to couple the smart lid to any suitable liquid container.

In another exemplary embodiment, the smart components may be installed within the container body. Such an embodiment may be easier to manufacture due to the increased room for positioning the smart components compared to the smart lid. In other embodiments, the smart components can be distributed on or within both the lid and the container body.

Numerous drinking containers including but not limited to travel mugs (for example, as disclosed in U.S. Pat. No. 7,546,933, which is hereby incorporated by reference herein), water bottles (for example, as disclosed in U.S. Pat. No. 8,602,238, which is hereby incorporated by reference herein), and tumblers, can be configured to be smart drinking containers according to the invention. In addition, drinking containers typically used for “serving” such as pitchers and thermoses can also be configured to be smart drinking containers according to the invention.

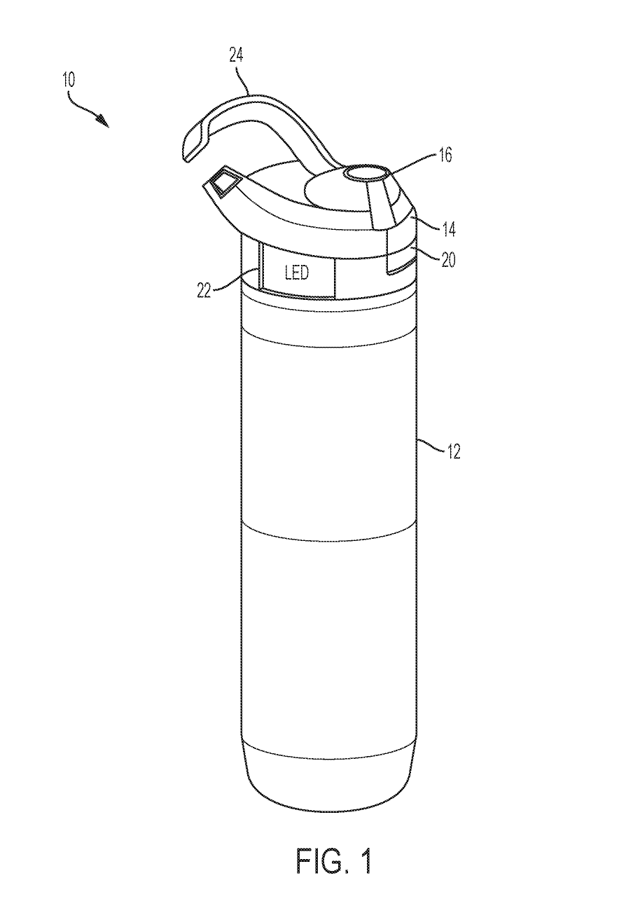

Referring now to the Figures, FIG. 1 shows an embodiment of a smart drinking container according to the present invention, specifically, a smart water bottle 10. The smart water bottle 10 is generally comprised of a container body 12 for holding liquid, which optionally may have a dual-walled construction, and a lid assembly 14 that may be sealably fastened and releasably coupled to the container body 12. If the container body has a dual-walled construction, such a dual-walled construction can be insulated with an insulating foam provided in a cavity between the walls or with a vacuum sealed construction to increase the thermal efficiency of the smart water bottle 10. The container body 12 may store a variety of liquids, both hot and cold, and thus the term “water bottle” as used herein is not limited to storing water. It will be recognized by those of ordinary skill in the art that each such component may be formed by single or multiple elements, separately or integrally formed. For example, the container body 12 may further include an overmolded sleeve (not shown) to improve the user's ability to grip the container body and/or the aesthetic appearance thereof. As another example, the lid assembly 14 may include a handle element 24 and the handle 24 may include a carabiner-type element (not shown) that may allow the handle 24 to be releasably coupled to another object such as a backpack strap or allow another object such as a key ring to be releasably coupled to the handle 24.

As explained in detail herein, the lid assembly 14 generally contains a drinking interface 16, disposed on or in a top surface of the lid assembly 14, which allows a user to consume liquid contained within the container body 12. Exemplary drinking interfaces 16 include a spout extending from a top surface of the lid assembly 14, a drink aperture extending through a top surface of the lid assembly 14, or a straw, with each being in fluid communication with an interior of and any fluid contents contained within the container body 12. In the illustrated embodiment, the drinking interface 16 is a spout. The illustration of FIG. 1 is not intended to be limiting; indeed, the structures of numerous liquid containers that may be further adapted to provide smart drinking containers according to the invention are well known in the art. In general, the drinking interface 16 can be of any suitable form provided that the drinking interface 16 may be used by a user to consume liquid from the drinking container 10. For example, the drinking interface 16 may comprise a straw, a spout, a nozzle, a drinking aperture, etc.

The smart water bottle 10 includes one or more actuators that, when activated, initiates a measurement of the volume of liquid in the drink container 10. In one embodiment, the actuator can take the form of an external button 20 accessible from the exterior of the smart drinking container 10 (e.g., on an exterior surface of the lid assembly 14), that when depressed, operates to pivot a shutter (not shown) and thereby open and close a seal (not shown) on the shutter for sealing the drinking interface 16. Thus, when the button 20 is depressed, liquid can be dispensed from the drinking interface 16 of the smart bottle 10 such that a user can consume liquid directly therefrom. According to this embodiment, release of the button 20 indicates to the processor (not shown) that a drink event has occurred, and thus release of the button 20 causes the volume of liquid in the container body 12 to be automatically measured. In another embodiment, the actuator 20 takes the form of a button accessible from the exterior of the smart drinking container 10 (e.g., on an exterior surface of the lid assembly 14), that either when depressed or when released, indicates to the processor (not shown in FIG. 1) that a drink event has occurred, and thus depression or release of the button 20 causes the volume of liquid in the container body 12 to be automatically measured.

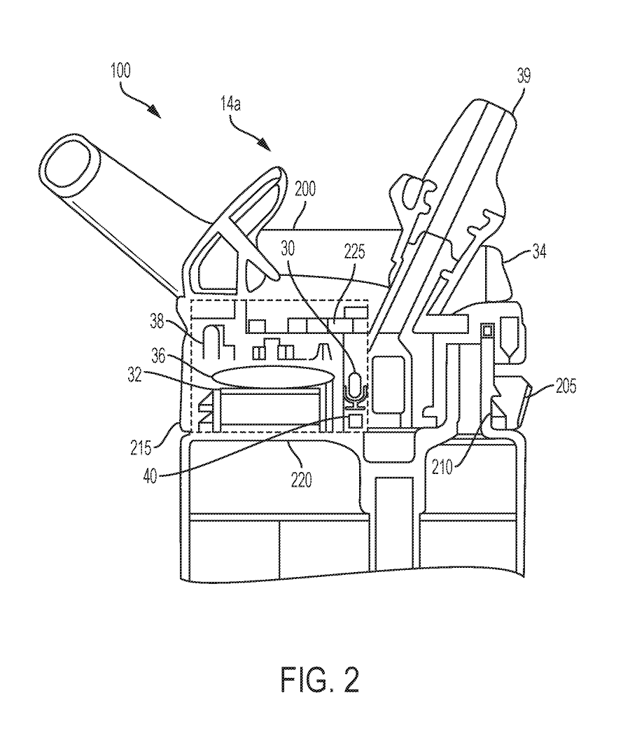

In other embodiments, as best illustrated in FIG. 2, the actuator is located in an interior enclosed compartment 225 of the lid assembly 14 and/or container body 12. For example, the actuator may be a tilt switch disposed in the interior compartment, which is activated when the lid assembly 14 is turned a number of degrees from vertical. As an example, the tilt switch can be configured to detect when the lid assembly 14a is tilted more than 15 degrees from vertical, more than 20 degrees from vertical, more than 25 degrees from vertical, more than 30 degrees from vertical, more than 35 degrees from vertical, more than 40 degrees from vertical, more than 45 degrees from vertical, and/or more than 50 degrees from vertical. Of course, the actuator may also be located external to the lid assembly 14 and/or container body 12. For example, the actuator may be implemented as an application for a device (smart phone, tablet, smart watch, etc.) communicatively coupled to the smart drinking container.

In another embodiment, the actuator may include conductive pins disposed within the fluid path. For example, the actuator may comprise conductive pins within the fluid path. The conductive pins may act as an electronic sensor that is activated when at least two pins are in contact with liquid. In this embodiment, the conductive pins may detect when liquid is moving through the fluid path, which would indicate a drink event. In this embodiment, the conductive pins may be located in any suitable location along the fluid pathway.

In other embodiments, the actuator may be a micro switch, a vibration switch, a touch sensor, for example, a conductivity-based touch sensor, or any other suitable sensor configured to detect a drink event. In yet a further embodiment, the actuator may be a timer that causes the volume of the container to be measured at pre-programmed time intervals which may or may not be regularly recurring time intervals. In a further embodiment, there may be one or more actuators, communicatively coupled to each other and the other smart components, which can each include different functionality for receiving an indication of a drink event. For example, the actuator of the smart bottle 10 may include two or more of a button 20 as described above, a tilt switch, and a timer.

Typically, the type of actuator employed in a smart drinking container according to the invention depends on the specific form of the smart drinking container 10. For example, a smart drinking container 10 that takes the form of a tumbler including a straw may not be compatible with a tilt switch, because a user will typically hold the smart tumbler 10 in a vertical position while drinking from the straw. By implementing an actuator, the smart drinking container 10 may conserve battery power by only measuring the volume of fluid at times corresponding to drink events.

Further, the actuator may be implemented as any combination of mechanical, electronic and/or chemical components. For example, the actuator may initiate a measurement of the volume of liquid in the drink container by employing any combination of sensors and button mechanisms working in unison to determine when a drink event occurs. For example, the actuator may include a button and a tilt sensor. In this example, the drink event may not commence until the both the button is depressed and the bottle is tilted a number of degrees from vertical. The drink event may then end once either the button is released and/or the bottle is returned to a sufficiently vertical position.

Still further, the smart water bottle 10 may include an LED display 22. The LED display may be provided on an exterior surface of the smart bottle 10. In preferred embodiments, the LED display may be disposed on an external sidewall of either the container body 12 or the lid assembly 14. The LED display 22 may be communicatively coupled to the smart components of the smart drinking container 10, as discussed in greater detail below. The LED display may display the amount of liquid consumed by a user on one or more regularly occurring bases, for example, the LED display may display the amount of liquid consumed by the user on a daily basis, a weekly basis, and/or a monthly basis. Further, the LED display may be selectively reset by the user to start measuring the amount of liquid consumed at any time, i.e., the LED display may selectively display the amount of liquid consumed by the user over any selected time period. Thus, in various embodiments, the LED display 22 may illustrate data related to the smart drinking container 10 and more particularly to liquid consumption by the user over one or more pre-defined and/or selected periods of time. Further, the LED display 22 may also include digital representations illustrating the current time, the current temperature, the current barometric pressure, the current battery life, and/or a digital map. For example, in one exemplary embodiment, the LED display 22 may indicate a remaining battery power of a battery of the smart drinking container 10, a total volume of liquid displaced/consumed over one or more drink events and a current volume of liquid in the container body 12. In some embodiments, the LED display 22 may be a display of a corresponding device (i.e. a smart phone, a tablet, a smart watch, or a PC) communicatively coupled to the smart bottle 10 via Bluetooth, fire wire, Wi-Fi, USB, etc., as discussed in greater detail below with respect to the antenna.

As explained above, the smart drinking container 10 may be a bottle including various smart components for measuring the volume of a liquid within the drink bottle 10 and calculating the amount of liquid consumed during one or more drinking events. The smart drinking container 10 may comprise a smart lid, i.e., a lid assembly 14 that contains all of the smart components. In another embodiment, the smart drinking container 10 may have all the smart components disposed on or within the container body 12. In still another embodiment, the smart components are disposed on or within both the lid assembly 14 and the container body 12 of the smart drinking container 10.

Referring to FIG. 2, a cross-sectional view showing internal features of a smart lid 14a is illustrated. In the embodiment illustrated in FIG. 2, the lid assembly is a smart lid 14a that contains all of the smart components of a smart drinking container 10. Generally, the smart lid 14a comprises a top lid surface 200, a sidewall 205 extending down annularly from the top lid surface 200 and terminating at a bottom edge 220, the annular sidewall 205 having an internal portion 210 and an external portion 215, where a section of the internal portion 210 may include threading for sealably fastening and releasably coupling the smart lid 14a to a container body 12. An interior, enclosed compartment 225 can be provided on an interior surface of the smart lid 14a. Such a compartment 225 can be referred to as an “in-lid” compartment because it is wholly contained between the top lid surface 200 and the bottom edge 220 of the smart lid 14a. Of course, a compartment external to the lid can also be used to contain the smart components of the smart drinking container 10, but an in-lid compartment is generally found to be more aesthetically pleasing and uses available space more efficiently.

The illustration of the smart lid 14a includes a drinking interface 39 which differs from the drinking interface 16 of FIG. 1 and is intended to illustrate a different embodiment of a drinking interface that can be utilized in a smart drinking container 10 according to the invention. The drinking interface 39 comprises a straw-like structural element that extends through the top surface 200 and is in fluid communication with the fluid contents contained within the interior of the container body 12.

As mentioned above, the smart lid 14a includes all of the “smart components” according to the invention, and these components are communicatively coupled to one another and powered by a battery 32 or other power source such as a solar cell. The smart components work together to determine that a drink event has occurred and, thus, that a volume measurement should be recorded, either substantially immediately after the drink event or once it has been determined that the drinking container is substantially vertical and/or at rest following a drink event. The smart components include a sensor comprising a microphone 30, an actuator 34, a processor 36, an amplifier 40, and may further include an antenna 38. The processor 36 may include a memory to store a starting volume of fluid in the container, a total volume of fluid consumed by the user, properties of the current container body, and/or any other information related to the smart drinking container 100. Although the actuator 34 of FIG. 2 is a push button actuator disposed on the external portion 215 of the sidewall 205, other actuators can be used in lieu of or in combination with actuator 34 as described above.

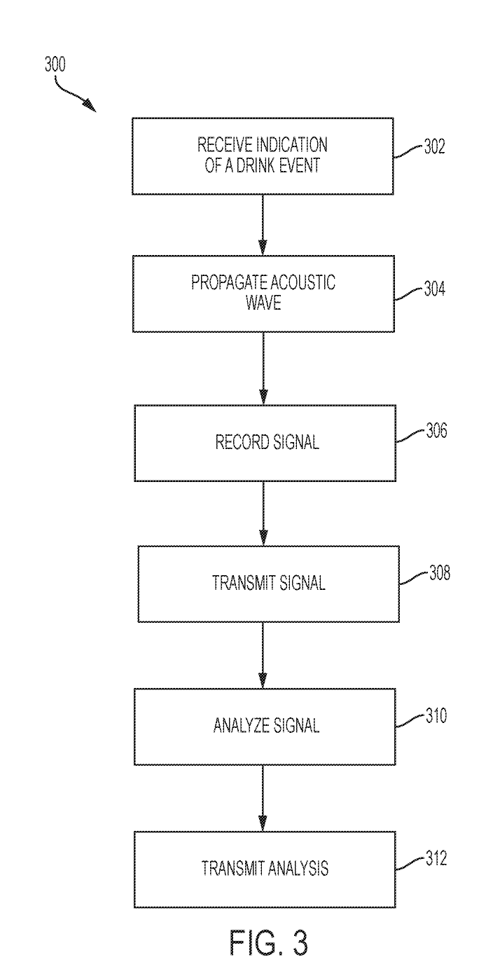

FIG. 3 illustrates a flow diagram of an example method 300 for measuring the volume of liquid contained in a smart drinking container incorporating the representative smart components illustrated in FIG. 2, i.e., microphone 30, actuator 34, processor 36, amplifier 40 and optionally antenna 38. Upon receiving an indication of a drink event (Block 302) via activation of the actuator 34, the smart components act in concert to measure the volume of liquid in the container body 12. In addition, although not shown as part of the exemplary method illustrated in FIG. 3, an initial measurement may be implemented to measure a starting volume of the empty drinking container. The initial measurement may be activated through an initial activation of the actuator, for example, in response to the smart lid 14a being sealably fastened to the container 12, or through another viable starting action, for example, depressing or releasing a button accessible from the exterior of the smart drinking container as described with respect to FIG. 1. Moving back to the method 300, once the actuator is activated, an acoustic wave is propagated throughout the container body (Block 304). The acoustic wave may be propagated by the amplifier 40. The amplifier 40 can be an integral part of the microphone 30 or can be a separate element coupled thereto. A signal derived from the acoustic wave is then recorded by the sensor (illustrated as microphone 30) (Block 306). As used herein, “a signal derived from the acoustic wave” is a signal that corresponds to the acoustic wave after interacting with the container body and returning to and being recorded by the microphone. In other embodiments, the sensor 30 comprises a piezoelectric disc microphone, also known as a piezo or contact microphone. In other embodiments, the sensor 30 comprises a condenser electret microphone. Further, any suitable sensor comprising a microphone 30 may be utilized by the smart bottle 10.

The recorded signal is then transmitted via wired connections to the processor 36 (Block 308). The processor 36 may then analyze the frequency of the recorded signal to determine the volume of liquid in the container body (Block 310). In one embodiment, the processor 36 may analyze the frequency of the recorded signal by implementing a frequency counter. However, other known suitable techniques can be used to analyze the recorded signal derived from the acoustic wave propagated by the amplifier 40. If the smart lid 14a is coupled to a container of known volume, the processor may easily calculate the volume of liquid in the container body based upon the cavity volume measurement. However, if the smart lid 14a is fastened to a container body of unknown volume, the processor may need to be calibrated before volumes can be accurately measured. The calibration process may require a user to activate the actuator with various known quantities of liquid in the container (e.g., a measurement is made when the container is filled to its intended volume and another measurement is made when the container is empty). The calibration process affords the smart lid 14a the ability to perform accurately with a wide variety of container bodies.

In another embodiment, the recorded signals may be transmitted to a server for analysis. The server may perform any of the calculations described with regard to the processor 36 above. In still other embodiments, a combination of a server and processor 36 may be enabled to calculate and store measurements of displaced liquid per drink event and/or a total volume of liquid displaced during multiple drink events.

Once the processor 36 analyzes the recorded signal, the analysis may be transmitted through wired connections to an LED display (such as the LED display 22 of FIG. 1) and/or through the optional antenna 38 to corresponding smart devices (Block 312). For example, the antenna 38 may allow the smart bottle to communicate with a smart phone, a tablet, a smart watch a personal computer or any other suitable computing device. The antenna may implement known wireless communication methods such as Bluetooth, Wi-Fi, radio waves, etc. Further, the antenna 38 may be configured to transmit signals to a server of a web application. The web application may be accessed by a user to view various data related to liquid consumption from the smart bottle.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. Additionally, the terms “first,” “second,” “third,” and “fourth” as used herein are intended for illustrative purposes only and do not limit the embodiments in any way. Further, the term “plurality” as used herein indicates any number greater than one, either disjunctively or conjunctively, as necessary, up to an infinite number. Additionally, the term “having” as used herein in both the disclosure and claims, is utilized in an open-ended manner.

It will be understood that the invention may be embodied in other specific forms without departing from the spirit or central characteristics thereof. The present disclosure and the illustrated embodiments, therefore, are to be considered in all respects as illustrative and not restrictive, and the invention is not to be limited to the details given herein. Accordingly, while specific embodiments have been illustrated and described, numerous modifications are readily apparent to one having ordinary skill in the art and the scope of protection should only be limited by the scope of the accompanying claims.

What is claimed:

1. A smart lid for a drink bottle comprising:
a drinking interface, on or in a top surface of the smart lid, for drinking;
a group of communicatively coupled smart components disposed on or within the smart lid, the smart components comprising:
an actuator which, when activated, indicates a drink event,
an amplifier for propagating an acoustic wave after the drink event is indicated by the actuator,
a sensor comprising a microphone for recording a signal derived from the acoustic wave,
a processor for analyzing the recorded signal, and
optionally, an antenna, for transmitting the analysis of the processor; and
a power source for supplying power to the smart components;
wherein the smart lid, when coupled to a container body, is configured to measure a volume of liquid in the container body based on the analysis of the processor.

2. The smart lid of claim 1, wherein the smart lid is capable of being calibrated for a container of undefined volume.

3. The smart lid of claim 1, wherein the actuator is located on an external sidewall of the smart lid and wherein the actuator is activated by a physical stimulus.

4. The smart lid of claim 1, further comprising an LED display located on an external sidewall or the top surface of the smart lid.

5. The smart lid of claim 1, wherein the antenna of the processor is configured to transmit the analysis to a corresponding device, wherein the corresponding device can be a smart phone, a tablet, a personal computer or a smart watch.

6. The smart lid of claim 1, wherein the antenna of the processor is configured to transmit the analysis to a server of a web application.

7. The smart lid of claim 1, wherein the drinking interface comprises one or more of a spout extending from the top surface, a drink aperture extending through the top surface, or a straw in fluid communication with an interior of the container body.

8. The smart lid of claim 1, wherein the actuator comprises one or more of a mechanical component, an electronic component, a chemical component, or a combination thereof.

9. A smart drinking container comprising:
a lid including a drinking interface, on or in a top surface of the lid, for drinking from the smart drinking container;
a container body coupled to the lid;
a group of communicatively coupled smart components disposed on or within one or both of the container body and the lid, the smart components comprising:
an actuator which, when activated, indicates a drink event,
an amplifier for propagating an acoustic wave after the drink event is indicated by the actuator,
a sensor comprising a microphone for recording a signal derived from the acoustic wave;
a processor for analyzing the recorded signal, and
optionally, an antenna, wherein the antenna is configured to transmit the analysis of the processor; and
a power source for supplying power to the smart components;
wherein the smart drinking container is configured to measure a volume of liquid in the container body based on the analysis of the processor.

10. The smart drinking container of claim 9 wherein the actuator is disposed in a fluid pathway fluidly coupled to the drinking interface and extending into the container body.

11. The smart drinking container of claim 9, wherein the actuator is located on an external sidewall of the container body.

12. The smart drinking container of claim 11, wherein the actuator is activated by a physical stimulus.

13. The smart drinking container of claim 9, wherein the actuator is a sensor that is activated when the smart drinking container is tilted a number of degrees from vertical.

14. The smart drinking container of claim 9, further comprising an LED display, located on an external sidewall or the top surface of the lid.

15. The smart drinking container of claim 9, wherein the antenna is configured to transmit the analysis to a corresponding device, wherein the corresponding device can be a smart phone, a tablet, a personal computer or a smart watch.

16. The smart drinking container of claim 9, wherein the antenna is configured to transmit the analysis to a server of a web application.

17. The smart drinking container of claim 9, wherein the smart drinking container is configured to determine a total volume of liquid displaced during one or more drink events.

18. A computer-implemented method for measuring a volume of liquid displaced from a smart bottle, the method including:
receiving, via an actuator, an indication that a drink event has occurred;
propagating, by an amplifier, an acoustic wave throughout a container body of a smart bottle;
recording, via a microphone, a signal derived from the acoustic wave;
transmitting, to one or more processors, the recorded signal;
analyzing, with the one or more processors, the recorded signal to determine a volume of liquid in the container; and,
optionally, transmitting, via an antenna, the determined volume of liquid in the container.

19. The computer-implemented method of claim 18, wherein one or more drink events are analyzed to determine a total volume of liquid displaced from the smart bottle.

20. The computer-implemented method of claim 19, wherein the determined total volume of liquid displaced from the smart bottle is displayed via a user interface of the smart bottle.
